(19) United States
(12) Patent Application Publication
(10) Pub. No.: US 2021/0365094 A1
(43) Pub. Date: Nov. 25, 2021

(54) STORAGE MEDIUM, METHOD AND APPARATUS FOR JOB POWER CONSUMPTION PREDICTION

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/172,645

(22) Filed: Feb. 10, 2021

(30) Foreign Application Priority Data
May 20, 2020 (JP) 2020-088501

(51) Int. Cl. G06F 1/28; G06F 1/329; G06F 1/3206

(52) U.S. Cl. CPC G06F 1/28; G06F 1/3206; G06F 1/329

(57) ABSTRACT

A job power consumption is predicted by a computer. For each waveform of a plurality of waveforms indicating a temporal change in power consumption of a job, divide the waveform into a plurality of partial waveforms each with a given length and creates a histogram for types of partial waveforms, and store the histogram in association with the waveform in a first storage area. A new histogram for a prediction target waveform of a new job is created. From the first storage area, waveforms respectively associated with a plurality of histograms to be combined together into an enlarged histogram in which each frequency of the created histogram is multiplied by a given number are selected. A power consumption of the new job is predicted by a prediction model adjusted by using the selected waveforms.

### CROSS-REFERENCE TO RELATED APPLICATION

This application is based upon and claims the benefit of priority of the prior Japanese Patent Application No. 2020-88501, filed on May 20, 2020, the entire contents of which are incorporated herein by reference.

### FIELD

The embodiment discussed herein is related to a storage medium, a method and apparatus for job power consumption prediction.

### BACKGROUND

In information processing such as high-performance computing (HPC), in order to reduce electricity charges, it is desirable to reduce power consumption. The electricity charges for one month are calculated by demand charge+energy charge rate×energy usage amount for one month. The demand charge is determined in accordance with the energy usage amount for 30 minutes during which the consumption of electric power was largest in the previous year. Therefore, if the average power consumption for 30 minutes exceeds the contract power even once, the electricity charges will increase in the next year.

In order to reduce the electricity charges, the power consumption of jobs is predicted, and the jobs are scheduled so that the power consumption does not exceed the contract power. The power consumption of jobs is predicted by using electric power time-series prediction. The electric power time-series prediction generates a prediction model by learning the previous results, and predicts the power consumption of jobs using the generated prediction model.

As a related technique for time-series prediction, a data processing apparatus has been developed for improving the accuracy of time-series prediction. The data processing apparatus divides time-series data into evenly-sized overlapping segments of data, and, for each segment, generates an image representing data in the segment. The data processing apparatus uses the time-series data to determine a trend associated with each image, and stores each of the generated images and its associated trend as a data set. Examples of the related art include Japanese Laid-open Patent Publication No. 2017-157213.

### SUMMARY

According to an aspect of the embodiments, a job power consumption prediction method includes: for each waveform of a plurality of waveforms that indicates a temporal change in power consumption of a job, performing cluster analysis that divides the waveform into a plurality of partial waveforms each with a given length and creates a histogram for types of partial waveforms using the plurality of partial waveforms, and storing the histogram created by the cluster analysis in association with the waveform in a first storage area; generating a prediction model for predicting the power consumption by performing learning using the plurality of waveforms; creating a new histogram by performing the cluster analysis for a prediction target waveform, the target waveform indicating a temporal change in power consumption of a new job; selecting, from the first storage area, waveforms respectively associated with a plurality of histograms to be combined together into an enlarged histogram in which each frequency of the created histogram is multiplied by a given number; adjusting the prediction model using the selected waveforms to generate an adjusted prediction model; and predicting power consumption of the new job using the adjusted prediction model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system according to an embodiment;

FIG. 2 is a diagram for explaining a recurrent neural network (RNN);

FIG. 3 is a diagram for explaining prediction models generated by a job power consumption prediction device;

FIG. 4 is a diagram for explaining cluster analysis;

FIG. 5 is a first diagram for explaining adjustment of a prediction model;

FIG. 6 is a second diagram for explaining adjustment of a prediction model;

FIG. 7 is a diagram for explaining a method for calculating a similarity in terms of the temporal change in the power of jobs;

FIG. 8 is a flowchart illustrating a flow of a prediction model generation process performed by the job power consumption prediction device;

FIG. 9 is a flowchart illustrating a flow of a prediction model adjustment process;

FIG. 10 is a flowchart illustrating a flow of a power prediction process performed by the job power consumption prediction device;

FIG. 11 includes diagrams illustrating effects of prediction performed by the job power consumption prediction device;

FIG. 12 is a diagram illustrating a hardware configuration of a computer that executes a job power consumption prediction program according to the embodiment; and

FIGS. 13A and 13B each include diagrams depicting examples of power consumption of jobs.

### DESCRIPTION OF EMBODIMENTS

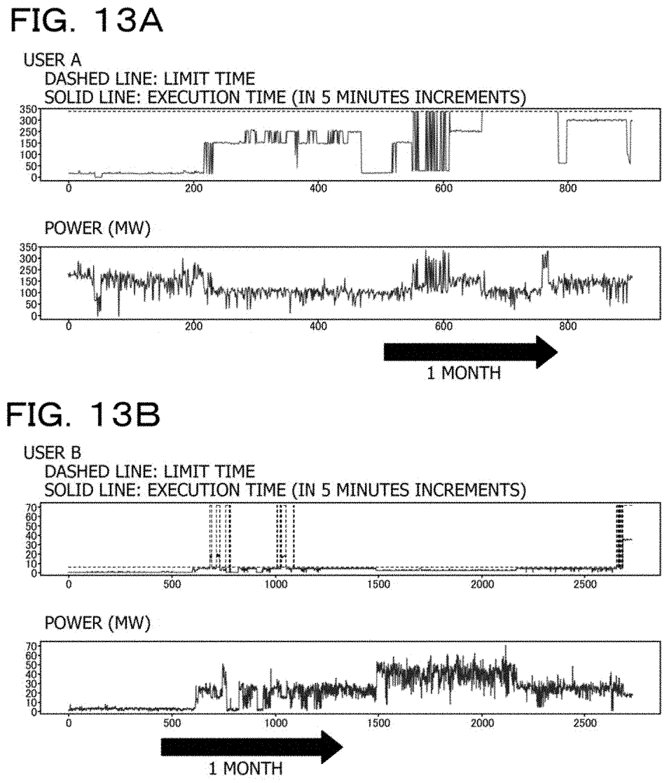

In the electric power time-series prediction using a prediction model, the learning time is long. For example, it takes 78 hours to learn 25,000 jobs executed for one month. In contrast, the trend in the power consumption of jobs changes fast. FIGS. 13A and 13B each include diagrams depicting examples of power consumption of jobs. FIG. 13A depicts power consumption of jobs of user A and FIG. 13B depicts power consumption of jobs of user B.

FIGS. 13A and 13B depict the execution times of jobs as well as the power consumptions of the jobs. The unit of power consumption is Megawatt (MW). For the execution time, the vertical axis has a scale of five minutes per division. The dashed line represents the time limit for jobs and the solid line represents the execution time for jobs. The horizontal axis represents the number identifying submission of jobs.

As depicted in FIGS. 13A and 13B, the trend of power consumption of jobs changes fast. For example, the trend of power consumption of jobs changes even in one month. Therefore, prediction following a change in the trend may not be achieved by predicting power consumption while learning the time-series data of new power consumption to update a prediction model.

In one aspect, the present disclosure is directed to prediction following a change in the trend of power consumption of jobs.

Hereinafter, an embodiment of a job power consumption prediction program, a job power consumption prediction method, and an information processing apparatus disclosed in this application will be described in detail with reference to the accompanying drawings. The embodiment does not limit the disclosed techniques.

### Embodiment

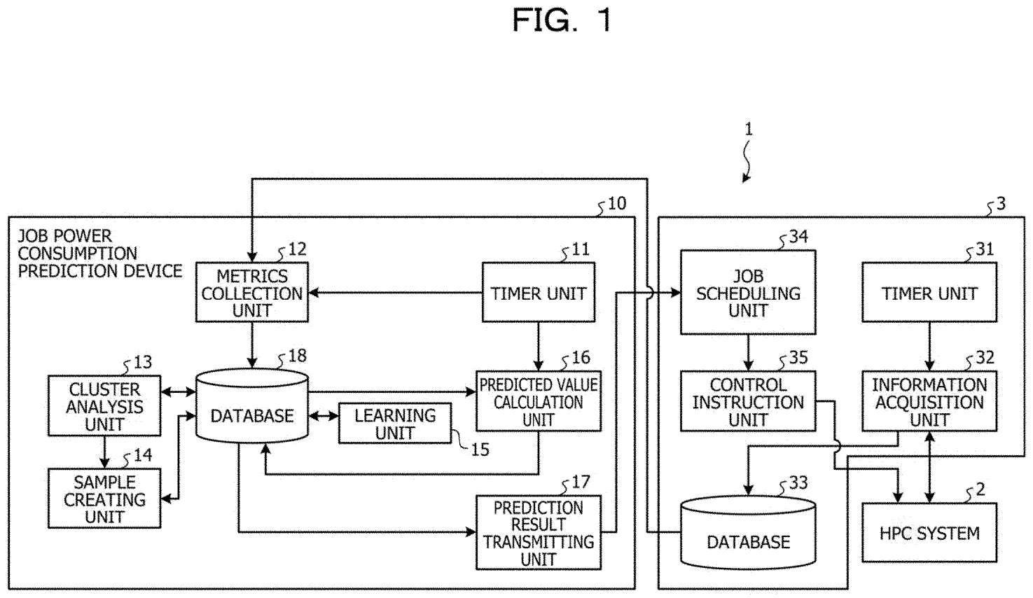

First, a configuration of an information processing system according to the embodiment is described. FIG. 1 is a diagram illustrating a configuration of an information processing system according to the embodiment. As illustrated in FIG. 1, an information processing system 1 according to the embodiment includes an HPC system 2, a management device 3, and a job power consumption prediction device 10.

The HPC system 2 is a supercomputer system to which jobs are submitted. The information processing system 1 may include another computer system in place of the HPC system 2. The management device 3 schedules jobs that are to be submitted to the HPC system 2. The management device 3 collects information for operation management of the HPC system 2. The job power consumption prediction device 10 predicts the power consumption of jobs based on the information collected by the management device 3 and notifies the management device 3 of the prediction.

The management device 3 includes a timer unit 31, an information acquisition unit 32, a database 33, a job scheduling unit 34, and a control instruction unit 35. The timer unit 31 activates the information acquisition unit 32 every certain time period. When activated by the timer unit 31, the information acquisition unit 32 collects information about the HPC system 2 and stores the collected information in the database 33. The information collected by the information acquisition unit 32 includes time-series information on power consumption of each job. The database 33 stores the information collected by the information acquisition unit 32.

The job scheduling unit 34 schedules jobs to be submitted to the HPC system 2 based on the power consumption prediction provided by the job power consumption prediction device 10 so that the average power consumption for 30 minutes will not exceed the contract power. The control instruction unit 35 instructs the HPC system 2 to execute jobs based on a schedule created by the job scheduling unit 34.

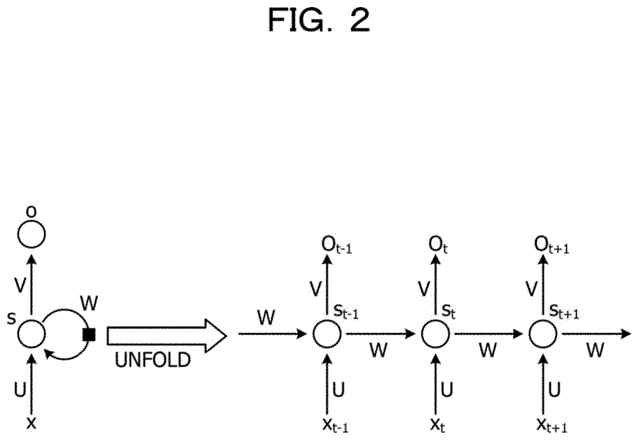

The job power consumption prediction device 10 predicts the power consumption of jobs using a recurrent neural network (RNN). FIG. 2 is a diagram for explaining an RNN. As illustrated in FIG. 2, in an RNN, x is input, a neuron state s is transitioned, and o is output. U is a value indicating the degree to which x affects a change in the state, W is a value indicating the degree to which the state affects the next state, and V is a value indicating the degree to which the state affects output. U, V, and W are adjusted by learning.

An RNN is unfolded into a plurality of neurons, and the neurons receive time-series data as input and produce time-series data as output. For example, assuming that the current time point is t, when time-series data consisting of six samples xₜ₋₅ to xₜ is input to an RNN, Oₜ₊₁ is a predicted value at the next time point.

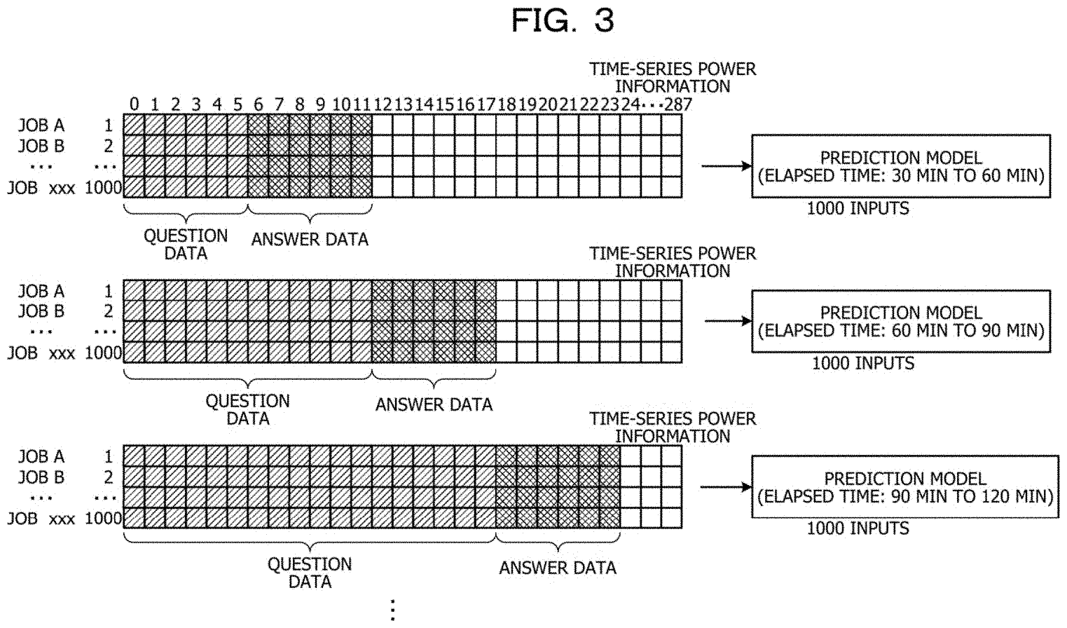

FIG. 3 is a diagram for explaining prediction models generated by the job power consumption prediction device 10. As illustrated in FIG. 3, the job power consumption prediction device 10 divides the time elapsed from the start of execution of jobs into a plurality of time zones and generates a prediction model for each time zone of the elapsed time. A data set for learning each prediction model consists of question data, which is electric power in a time period before the corresponding time zone, and answer data, which is electric power in the corresponding time zone.

For example, the job power consumption prediction device 10 divides the elapsed time from the start of execution of jobs into time zones at 30-minute intervals. The job power consumption prediction device 10 generates a data set for each of the time zones at 30-minute intervals. For example, in the case where the number of jobs for which the electric power value is measured is 1,000, the job power consumption prediction device 10 inputs 1,000 pieces of time-series power data to each prediction model and thus learns each prediction model.

For example, the job power consumption prediction device 10 extracts, from time-series power information, the power consumption of jobs during the elapsed time from 0 to 30 minutes (measurement point numbers 0 to 5) as question data. The job power consumption prediction device 10 then extracts, from the time-series power information, the power consumption of jobs during the elapsed time from 30 to 60 minutes (measurement point numbers 6 to 11) as answer data. The job power consumption prediction device 10 then constructs a set of the extracted question data and answer data as a data set for generating a prediction model for power consumption prediction for the time zone of the elapsed time from 30 to 60 minutes.

The job power consumption prediction device 10 extracts, from the time-series power information, the power consumption of jobs during the elapsed time from 0 to 60 minutes (measurement point numbers 0 to 11) as question data. The job power consumption prediction device 10 then extracts, from the time-series power information, the power consumption of jobs during the elapsed time from 60 to 90 minutes (measurement point numbers 12 to 17) as answer data. The job power consumption prediction device 10 then constructs a set of the extracted question data and answer data as a data set for generating a prediction model for power consumption prediction for the time zone of the elapsed time from 60 to 90 minutes.

The job power consumption prediction device 10 extracts, from the time-series power information, the power consumption of jobs during the elapsed time from 0 to 90 minutes (measurement point numbers 0 to 17) as question data. The job power consumption prediction device 10 then extracts, from the time-series power information, the power consumption of jobs during the elapsed time from 90 to 120 minutes (measurement point numbers 18 to 23) as answer data. The job power consumption prediction device 10 then constructs the extracted question data and answer data as a data set for generating a prediction model for power consumption prediction for the time zone of the elapsed time from 90 to 120 minutes.

In this way, the job power consumption prediction device 10 generates a prediction model for each time zone obtained by dividing the elapsed time from the start of execution of jobs. For generation of each prediction model, time-series changes in the power consumption of jobs in all the time periods prior to the prediction target period are used as the question data.

The job power consumption prediction device 10 includes a timer unit 11, a metrics collection unit 12, a cluster analysis unit 13, a sample creating unit 14, a learning unit 15, a predicted value calculation unit 16, a prediction result transmitting unit 17, and a database 18.

The timer unit 11 activates the metrics collection unit 12 for each certain time period. When a time period specified by the predicted value calculation unit 16 has elapsed, the timer unit 11 notifies the predicted value calculation unit 16.

The metrics collection unit 12 acquires time-series information on power consumption of each job from the management device 3 and stores the acquired time-series information in the database 18.

The cluster analysis unit 13 references the database 18 and performs cluster analysis for a waveform indicating a temporal change in the power consumption of jobs. In the cluster analysis, a waveform having a first length is divided into a plurality of partial waveforms having a second length, and a histogram for the types of partial waveforms is created using the plurality of partial waveforms.

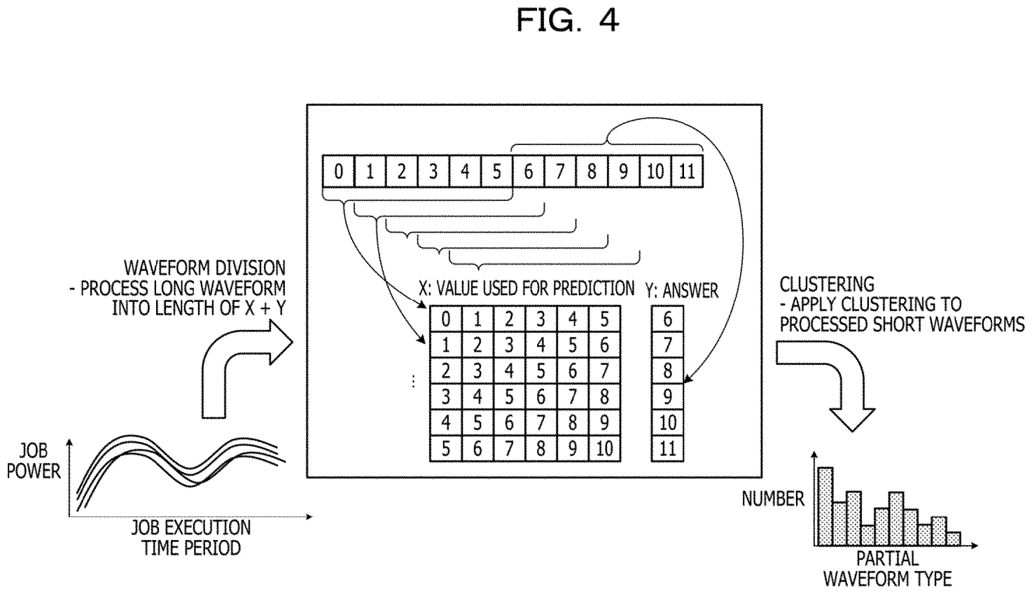

FIG. 4 is a diagram for explaining cluster analysis. In the description with reference to FIG. 4 and the following figures, power consumption may be referred to simply as power. As illustrated in FIG. 4, the cluster analysis unit 13 processes, into a length of X+Y, a long waveform in which a job execution time period is associated with the power of jobs (job power), such as a long waveform indicating a temporal change in the job power. X and Y are, respectively, the number of pieces of question data and the number of pieces of answer data (predicted value) used for prediction in an RNN that the job power consumption prediction device 10 uses for the prediction. In FIG. 4, X=6 and Y=6. The cluster analysis unit 13 applies clustering to a plurality of short waveforms obtained by the processing and creates a histogram for the types of short waveforms.

The cluster analysis unit 13 performs cluster analysis for each of a plurality of previous waveforms of job power and stores the created histograms in association with the respective analyzed waveforms in the database 18. The cluster analysis unit 13 also performs cluster analysis for a prediction target waveform, which is the waveform of a new job power to be predicted, and stores the created new histogram in association with the analyzed prediction target waveform in the database 18.

For the histogram created by cluster analysis of the prediction target waveform, the sample creating unit 14 multiplies the frequency of each partial waveform type by a given value to create an enlarged histogram. The given value is, for example, 10. The sample creating unit 14 retrieves, from the database 18, a plurality of histograms that, when combined together, form an enlarged histogram. The sample creating unit 14 uses waveforms respectively associated with the plurality of retrieved histograms to create an adjustment data set, which is a data set used for adjustment of a prediction model.

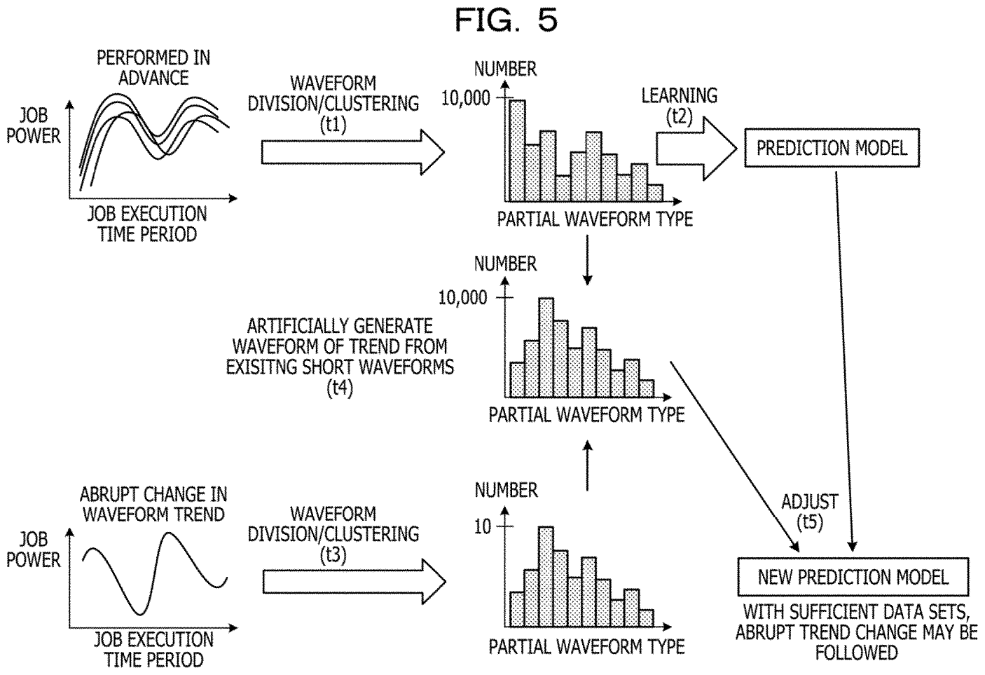

FIG. 5 is a first diagram for explaining adjustment of a prediction model. As illustrated in FIG. 5, the job power consumption prediction device 10 performs cluster analysis in advance for a plurality of previous waveforms of the job power (t1) and stores analysis results in the database 18. The job power consumption prediction device 10 creates a prediction model based on the plurality of previous waveforms of the job power (t2).

Upon acquiring a prediction target waveform, the job power consumption prediction device 10 performs cluster analysis for this waveform to create a histogram (t3). The job power consumption prediction device 10 creates an enlarged histogram from the created histogram and retrieves, from the database 18, a plurality of waveforms that are combined together to form the enlarged histogram. For example, the job power consumption prediction device 10 artificially generates a waveform indicating the trend of job power to be predicted (t4).

The job power consumption prediction device 10 then creates an adjustment data set using the plurality of waveforms retrieved from the database 18. The job power consumption prediction device 10 then adjusts the prediction model using the created adjustment data set (t5). The job power consumption prediction device 10 creates adjustment data sets respectively for time zones obtained by dividing the time elapsed from the start of execution of jobs, and adjusts the prediction models using the created adjustment data sets.

In this way, the job power consumption prediction device 10 may create a prediction model following an abrupt change in a trend of a prediction target waveform by artificially generating a waveform indicating the trend of job power to be predicted.

The learning unit 15 creates a prediction model for predicting the power using the time-series information on power of each job stored in the database 18, and stores the created prediction model in the database 18. The learning unit 15 adjusts a prediction model using an adjustment data set created by the sample creating unit 14, and stores the prediction model after the adjustment as an adjusted prediction model in the database 18.

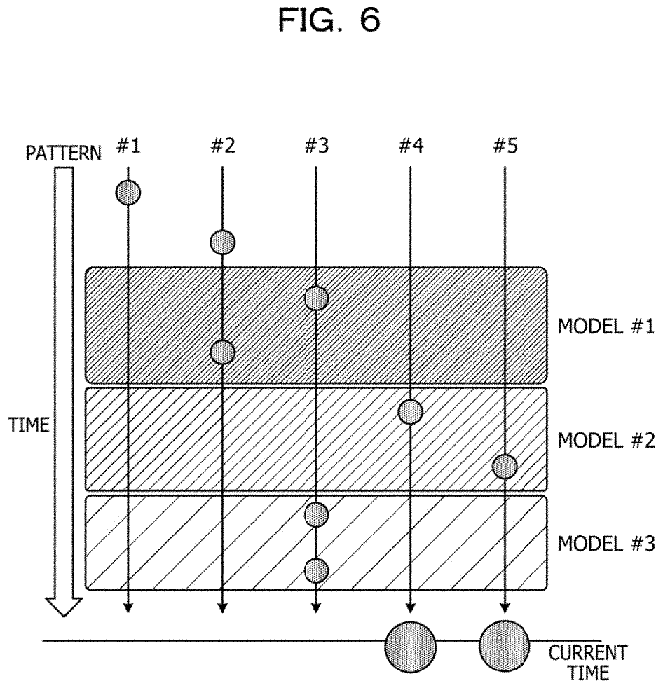

The learning unit 15 adjusts a prediction model each time that information is collected by the metrics collection unit 12. For example, the learning unit 15 adjusts a prediction model for each certain time period. FIG. 6 is a second diagram for explaining adjustment of a prediction model. In FIG. 6, time advances from top to bottom. “Current time” indicates the current time point at which a prediction model is being adjusted. “Model #3” is an adjusted prediction model generated at a certain time period prior to the current time point, “model #2” is an adjusted prediction model generated at the certain time period prior to “model #3”, and “model #1 is an adjusted prediction model generated at the certain time period prior to “model #2”.

The pattern indicates the type of a temporal change in the power of jobs. The circle indicates that there are a large number of corresponding patterns. When model #1 is generated, there are large numbers of pattern #3 and pattern #2. When model #2 is generated, there are large numbers of pattern #4 and pattern #5. When model #3 is generated, there are a large number of patterns #3.

At “current time”, there are large numbers of pattern #4 and pattern #5. Accordingly, rather than model #3 immediately prior to a prediction model at “current time”, model #2 is similar to the prediction model at “current time”. Therefore, the learning unit 15 selects model #2 as a prediction model on which adjustment is made. For example, the learning unit 15 adjusts model #2 using an adjustment data set created by the sample creating unit 14.

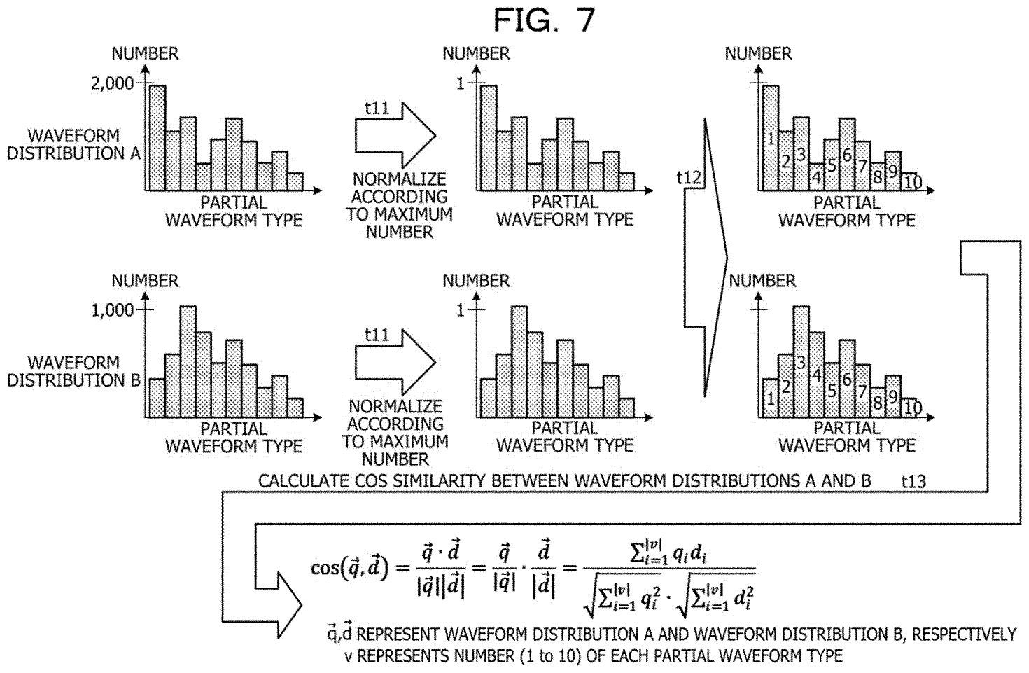

The learning unit 15 determines a similarity in terms of the temporal change in power of jobs using histograms created by cluster analysis. FIG. 7 is a diagram for explaining a method for calculating a similarity in terms of the temporal change in the power of jobs. In FIG. 7, waveform distributions are histograms created by cluster analysis. A waveform distribution A is the latest waveform distribution and a waveform distribution B is a previous waveform distribution. There are a plurality of waveform distributions B.

As illustrated in FIG. 7, the learning unit 15 normalizes the waveform distribution A and the waveform distribution B according to the respective maximum numbers of frequencies (t11). The learning unit 15 creates a vector whose elements are frequencies of partial waveform types (t12). In FIG. 7, the number of partial waveform types is 10, and the number v of elements of the vector is 10. The learning unit 15 creates vector q from the waveform distribution A and creates vector d from the waveform distribution B. In FIG. 7, vector q is represented as q above which →is added, and vector d is represented as d above which →is added.

The learning unit 15 calculates the cosine similarity (cos similarity) between vector q and vector d as the similarity between the waveform distribution A and the waveform distribution B (t13). The cos similarity between vector q and vector d is a value obtained by dividing the inner product of vector q and vector d by the magnitude of vector q and the magnitude of vector d.

The learning unit 15 stores an adjusted prediction model generated for each certain time period in association with the waveform distribution of a waveform used for the adjustment in the database 18, and acquires, from the database 18, an adjusted prediction model associated with a waveform distribution similar to the waveform distribution of a prediction target waveform. The learning unit 15 adjusts the adjusted prediction model acquired, using an adjustment data set, and stores a prediction model obtained by the adjustment, as an adjusted prediction model at the current time point, in the database 18.

Referring back to FIG. 1, the predicted value calculation unit 16 calculates a predicted value of power of jobs using time-series data of power of jobs and the most recent adjusted prediction model, which has been adjusted by the learning unit 15, and stores the calculated predicted value in the database 18.

The prediction result transmitting unit 17 reads out the predicted value calculated by the predicted value calculation unit 16 from the database 18 and transmits the predicted value to the management device 3.

The database 18 stores information related to prediction of power of jobs. For example, the database 18 stores time-series information on power consumption of each job, information associating a histogram created by cluster analysis with a waveform subjected to the analysis, and information on an adjustment data set created by the sample creating unit 14. The database 18 also stores information on a prediction model created by the learning unit 15 and information on a predicted value calculated by the predicted value calculation unit 16. The database 18 stores an adjusted prediction model generated for each certain time period in association with the waveform distribution of a waveform used for the adjustment.

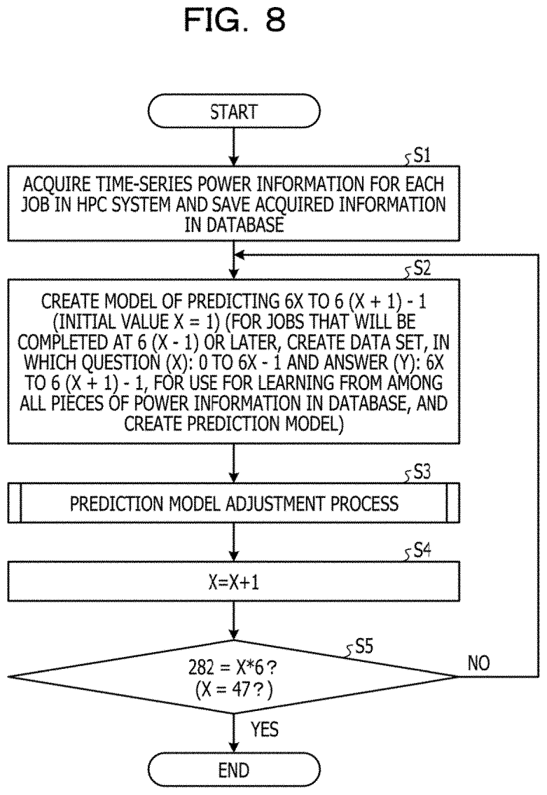

Next, process flows performed by the job power consumption prediction device 10 are described with reference to FIGS. 8 to 10. FIG. 8 is a flowchart illustrating a flow of a prediction model generation process performed by the job power consumption prediction device 10. The prediction model generation process illustrated in FIG. 8 is started at certain time intervals. The database 18 stores adjusted prediction models previously generated in the prediction model generation process and data used for generating the adjusted prediction models.

As illustrated in FIG. 8, the job power consumption prediction device 10 acquires time-series power information for each job in the HPC system 2 and saves the acquired information in the database 18 (step S1). The job power consumption prediction device 10 creates a model of predicting 6X to 6 (X+1)−1, where the initial value of X is one, using an RNN (step S2). For example, for jobs that will be completed at 6 (X−1) or later, the job power consumption prediction device 10 creates a data set, in which question (X): 0 to 6X−1 and answer (Y): 6X to 6 (X+1)−1, for use for learning from among all the pieces of power information in the database, and creates a prediction model.

The job power consumption prediction device 10 preforms, for a prediction model for each job, a prediction model adjustment process to adjust the prediction model so that the prediction model reflects the trend of the most recent power information (step S3). The job power consumption prediction device 10 adds one to X (step S4), and determines whether X multiplied by six (X*6) is 282, namely, whether X=47 (step S5).

It is assumed that the maximum length of a data set is 288. The maximum length of a data set depends on the length of a job. For example, assuming that the execution time for a job is 24 hours=1,440 minutes, when data taken every five minutes is used as power information, the number of pieces of data is 1,440 minutes/5 minutes=288. Six pieces of data are obtained every 30 minutes.

If X*6 is not 282, the job power consumption prediction device 10 returns to step S2. If X*6 is 282, the job power consumption prediction device 10 terminates the prediction model generation process.

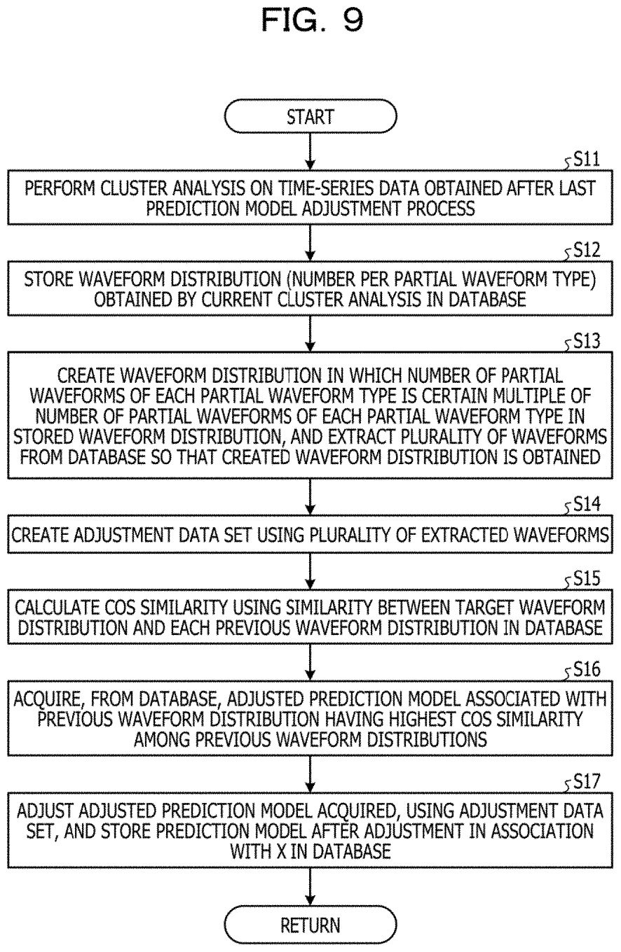

FIG. 9 is a flowchart illustrating a flow of a prediction model adjustment process. As illustrated in FIG. 9, the job power consumption prediction device 10 performs cluster analysis on time-series data obtained after the last prediction model adjustment process (step S11). The job power consumption prediction device 10 stores a waveform distribution (the number per partial waveform type) obtained by the current cluster analysis in the database 18 (step S12).

The job power consumption prediction device 10 creates a waveform distribution in which the number of partial waveforms of each partial waveform type is a given multiple of the number of partial waveforms of each partial waveform type in the stored waveform distribution, and extracts a plurality of waveforms from the database 18 so that the created waveform distribution is obtained (step S13). The job power consumption prediction device 10 then creates an adjustment data set using the plurality of extracted waveforms (step S14).

The job power consumption prediction device 10 calculates the cos similarity using the similarity between a target waveform distribution and each of previous waveform distributions in the database (step S15). The target waveform distribution is the waveform distribution that is stored in the database 18 in step S12. The job power consumption prediction device 10 acquires, from the database 18, an adjusted prediction model associated with a previous waveform distribution having the highest cos similarity among the previous waveform distributions (step S16).

The job power consumption prediction device 10 adjusts the adjusted prediction model acquired, using an adjustment data set, and stores the prediction model after the adjustment in association with X in the database 18 (step S17). The job power consumption prediction device 10 predicts power using the most recent adjusted prediction model.

In this way, the job power consumption prediction device 10 may create a prediction model reflecting the most recent power consumption by creating an adjustment data set and performing adjustment using the created adjustment data set and an adjusted prediction model that is most similar to a target waveform distribution.

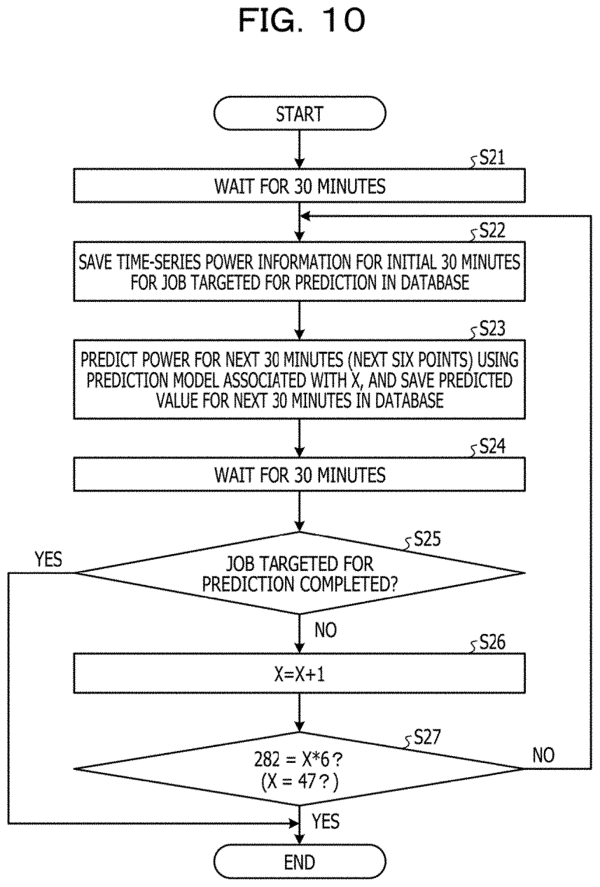

FIG. 10 is a flowchart illustrating a flow of a power prediction process performed by the job power consumption prediction device 10. The power prediction process illustrated in FIG. 10 is started each time that a job targeted for prediction is submitted. The job power consumption prediction device 10 uses 5-minute interval power information.

As illustrated in FIG. 10, the job power consumption prediction device 10 waits for 30 minutes (step S21) and saves time-series power information for the initial 30 minutes for the job targeted for prediction in the database 18 (step S22). The job power consumption prediction device 10 predicts the power for the next 30 minutes (the next six points) using the prediction model associated with X, and saves a predicted value for the next 30 minutes in the database 18 (step S23). The initial value of X is one. The prediction model is an adjusted prediction model.

The job power consumption prediction device 10 waits for 30 minutes (step S24), determines whether the job targeted for prediction has been completed (step S25), and terminates the power prediction process if the job has been completed. If the job targeted for prediction has not been completed, the job power consumption prediction device 10 adds one to X (step S26), and determines whether X*6 is 282, namely, whether X=47 (step S27).

If X*6 is not 282, the job power consumption prediction device 10 returns to step S22. If X*6 is 282, the job power consumption prediction device 10 terminates the power prediction process.

In this way, the job power consumption prediction device 10 predicts power using an adjusted prediction model and therefore may accomplish prediction that reflects the most recent change in the trend of power.

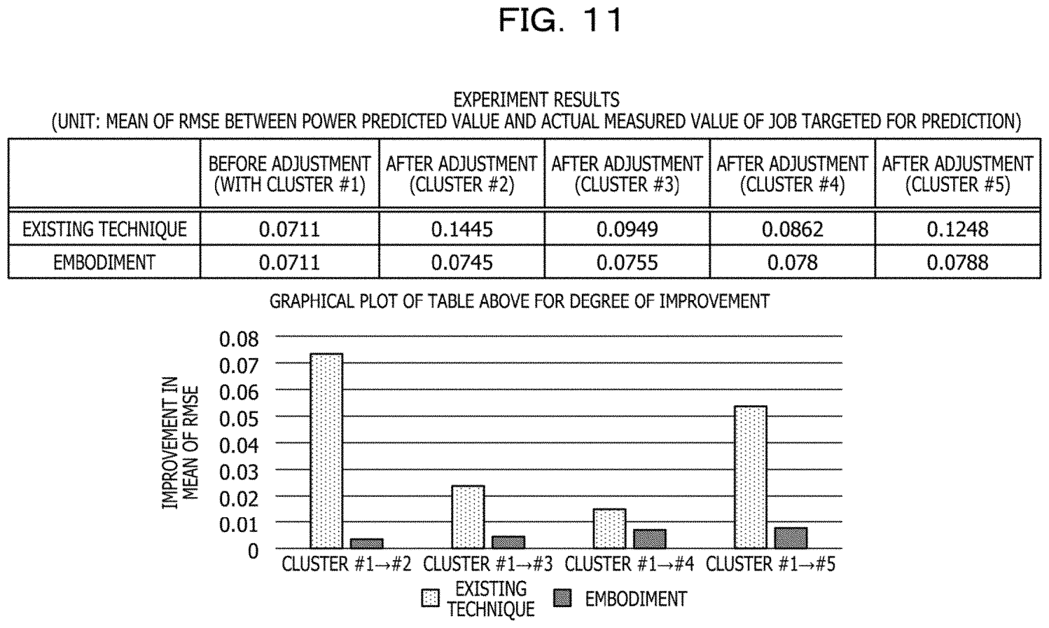

FIG. 11 includes diagrams illustrating effects of prediction performed by the job power consumption prediction device 10. In FIG. 11, cluster #1 is a group of 500 waveforms of job power that are similar in behavior. Cluster #2 to cluster #5 are groups of waveforms that are not similar in behavior to waveforms included in cluster #1. FIG. 11 illustrates the cases where a prediction model generated using cluster #1 is adjusted using each of cluster #2 to cluster #5. In an existing technique, data on waveforms included in each of cluster #2 to cluster #5 is used as it is. In the embodiment, 10 times as much data produced from each of cluster 2 to cluster #5 are used. Each value in the table is the mean of root-mean-square error (RMSE) between the power predicted value and the actual measured value. The graph represents values respectively obtained by subtracting the mean of RMSE of cluster #1 from the means of RMSE of cluster #2 to cluster #5.

As depicted in the table in FIG. 11, the mean of RMSE of a prediction model with cluster #1 is 0.0711. For cluster #2, compared with the mean of RMSE in the existing technique is 0.1445, the mean of RMSE in the embodiment is 0.0745. For example, the mean of RMSE in the embodiment is better than that in the existing technique. Similarly, for cluster #3 to cluster #5, the mean of RMSE in the embodiment is better than that in the existing technique. Accordingly, it may be understood that, compared with the existing technique, the job power consumption prediction device 10 follows a change in the trend of power well.

As described above, in the embodiment, the cluster analysis unit 13 performs cluster analysis for a plurality of waveforms indicating a temporal change in the power consumption of jobs to create histograms, and stores the created histograms in association with the analyzed waveforms in the database 18. The learning unit 15 generates a prediction model for predicting the power consumption of jobs by performing leaning using a plurality of waveforms indicating a temporal change in the power consumption of jobs. The cluster analysis unit 13 performs cluster analysis for the prediction target waveform to create a histogram for the power to be predicted. For the histogram for the power to be predicted, the sample creating unit 14 multiplies the frequency of each partial waveform type by a given value to create an enlarged histogram. The sample creating unit 14 retrieves, from the database 18, a plurality of histograms that, when combined together, form an enlarged histogram, and creates an adjustment data set used for adjustment of a prediction model, using waveforms respectively associated with the plurality of retrieved histograms. The learning unit 15 adjusts the prediction model using the adjustment data set, generating an adjusted prediction model. The predicted value calculation unit 16 predicts the target power using the adjusted prediction model. Accordingly, the job power consumption prediction device 10 may achieve prediction that follows a change in the trend of power consumption of jobs.

In the embodiment, the database 18 stores an adjusted prediction model in association with the waveform distribution of a waveform used for creating an adjustment data set. In adjusting a prediction model, the learning unit 15 selects, from the database 18, an adjusted prediction model associated with a waveform distribution similar to the waveform distribution of a prediction target waveform from the last adjustment to the current adjustment, and adjusts the selected adjusted prediction model using an adjustment data set. Accordingly, a prediction model that more reflects a change in the trend of power consumption of jobs may be generated.

In the embodiment, the learning unit 15 identifies a waveform distribution similar to the waveform distribution of a prediction target waveform, by using the cos similarity, and therefore the similar waveform distribution may be accurately identified.

Although the job power consumption prediction device 10 has been described in the embodiment, a job power consumption prediction program having similar functions may be obtained by implementing the configuration of the job power consumption prediction device 10 by software. A computer that executes the job power consumption prediction program will now be described.

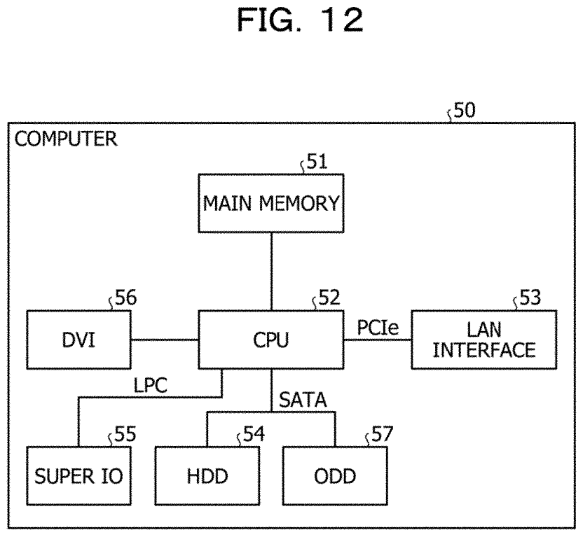

FIG. 12 is a diagram illustrating a hardware configuration of a computer that executes a job power consumption prediction program according to the embodiment. As illustrated in FIG. 12, a computer 50 includes a main memory 51, a central processing unit (CPU) 52, a local area network (LAN) interface 53, and a hard disk drive (HDD) 54. The computer 50 also includes a super input/output (IO) 55, a digital visual interface (DVI) 56, and an optical disk drive (ODD) 57.

The main memory 51 is a memory that stores programs, intermediate execution results of programs, and the like. The CPU 52 is a central processing unit that reads out a program from the main memory 51 and executes the program. The CPU 52 includes a chipset having a memory controller.

The LAN interface 53 is an interface for coupling the computer 50 to another computer over a LAN. The HDD 54 is a disk device that stores programs and data, and the super IO 55 is an interface for coupling input devices such as a mouse and a keyboard. The DVI 56 is an interface that couples a liquid crystal display device, and the ODD 57 is a device that reads data from or write data to a digital versatile disc (DVD).

The LAN interface 53 is coupled to the CPU 52 by a Peripheral Component Interconnect Express (PCIe). The HDD 54 and the ODD 57 are coupled to the CPU 52 by a serial advanced technology attachment (SATA). The super IO 55 is coupled to the CPU 52 by a low pin count (LPC).

The job power consumption prediction program that is executed on the computer 50 is stored in a DVD as an example of a recording medium readable by the computer 50, is read out from the DVD by the ODD 57, and is installed in the computer 50. Alternatively, the job power consumption prediction program is stored in a database or the like of another computer system coupled via the LAN interface 53, is read out from the database or the like, and is installed in the computer 50. The installed job power consumption prediction program is stored in the HDD 54, is read out into the main memory 51, and is executed by the CPU 52.

Although the embodiment illustrates that a prediction model is generated using an RNN, the job power consumption prediction device 10 may use another learning model, such as another neural network.

Although the embodiment illustrates that an elapsed time from the start of execution of jobs is divided into a plurality of time zones and a prediction model for each time zone of the elapsed time is generated, the job power consumption prediction device 10 may generate a single prediction model that does not depend on the elapsed time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a job power consumption prediction program for causing a computer to execute a process, the process comprising:
for each waveform of a plurality of waveforms that indicates a temporal change in power consumption of a job, performing cluster analysis that divides the waveform into a plurality of partial waveforms each with a given length and creates a histogram for types of partial waveforms using the plurality of partial waveforms, and storing the histogram created by the cluster analysis in association with the waveform in a first storage area;
generating a prediction model for predicting the power consumption by performing learning using the plurality of waveforms;
creating a new histogram by performing the cluster analysis for a prediction target waveform, the target waveform indicating a temporal change in power consumption of a new job;
selecting, from the first storage area, waveforms respectively associated with a plurality of histograms to be combined together into an enlarged histogram in which each frequency of the created histogram is multiplied by a given number;
adjusting the prediction model using the selected waveforms to generate an adjusted prediction model; and
predicting power consumption of the new job using the adjusted prediction model.

2. The non-transitory computer-readable storage medium according to claim 1, the process further comprising:
storing, in a second storage area, each of a plurality of adjusted prediction models obtained by adjusting the prediction model a plurality of times for each certain time period along with progress of the new job, in association with a histogram created by performing the cluster analysis for a waveform indicating a temporal change in the power consumption from a time point the certain time period prior to a time point of each adjustment to the time point of each adjustment; and
in performing adjustment of the prediction model, selecting, from the second storage area, an adjusted prediction model associated with a histogram similar to a histogram created by performing the cluster analysis for the prediction target waveform from a time point the certain time period prior to a time point of the adjustment to the time point of the adjustment, and adjusting the selected adjusted prediction model.

3. The non-transitory computer-readable storage medium according to claim 2, wherein
selecting the adjusted prediction model from the second storage area is performed using cosine similarity.

4. The non-transitory computer-readable storage medium according to claim 1, wherein
the prediction model and the adjusted prediction model are generated using a recurrent neural network (RNN).

5. The non-transitory computer-readable storage medium according to claim 1, wherein
a time period elapsed from start of job execution is divided into a plurality of time zones, and a model for each time zone of the elapsed time is generated both as the prediction model and as the adjusted prediction model.

6. A job power consumption prediction method performed by a computer, the method comprising:
for each waveform of a plurality of waveforms that indicates a temporal change in power consumption of a job, performing cluster analysis that divides the waveform into a plurality of partial waveforms each with a given length and creates a histogram for types of partial waveforms using the plurality of partial waveforms, and storing the histogram created by the cluster analysis in association with the waveform in a first storage area;
generating a prediction model for predicting the power consumption by performing learning using the plurality of waveforms;
creating a new histogram by performing the cluster analysis for a prediction target waveform, the target waveform indicating a temporal change in power consumption of a new job;
selecting, from the first storage area, waveforms respectively associated with a plurality of histograms to be combined together into an enlarged histogram in which each frequency of the created histogram is multiplied by a given number;
adjusting the prediction model using the selected waveforms to generate an adjusted prediction model; and
predicting power consumption of the new job using the adjusted prediction model.

7. A job power consumption prediction apparatus comprising:
a memory, and
a processor coupled to the memory and configured to:
perform, for each waveform of a plurality of waveforms that indicates a temporal change in power consumption of a job, cluster analysis that divides the waveform into a plurality of partial waveforms each with a given length and create a histogram for types of partial waveforms using the plurality of partial waveforms, and store the histogram created by the cluster analysis in association with the waveform in a first storage area;
generate a prediction model for predicting the power consumption by performing learning using the plurality of waveforms;
create a new histogram by performing the cluster analysis for a prediction target waveform, the target waveform indicating a temporal change in power consumption of a new job;
select, from the first storage area, waveforms respectively associated with a plurality of histograms to be combined together into an enlarged histogram in which each frequency of the created histogram is multiplied by a given number;
adjust the prediction model using the selected waveforms to generate an adjusted prediction model; and
predict power consumption of the new job using the adjusted prediction model.
